(19) United States
(12) Patent Application Publication
(10) Pub. No.: US 2010/0120878 A1
(43) Pub. Date: May 13, 2010

(54) FORMULATION

(75) Inventors: Jean-Charles Daniel Nicolas Broquet, Bracknell (GB); Richard Chi Shing Chung, Bracknell (GB); Gordon Alastair Bell, Bracknell (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/519,301

(22) PCT Filed: Dec. 4, 2007
(86) PCT No.: PCT/GB07/04636

§ 371 Date: Jan. 13, 2010

(30) Foreign Application Priority Data
Dec. 15, 2006 (GB) 0625095.5

(51) Int. Cl. A01N 43/653; A01P 3/00

(52) U.S. Cl. 514/383

(57) ABSTRACT

This invention relates to mixtures of triazole compounds and in particular to the use of such mixtures in non-crystallising compositions. It relates to mixtures that are concentrated solutions and also to the use of the concentrated solutions in water diluted form. Furthermore, it relates to the use of such mixtures for agricultural or materials protection purposes and to the use of one triazole compound to prevent or delay crystallisation of a second triazole compound.

This invention relates to mixtures of triazole compounds and in particular to the use of such mixtures in non-crystallising compositions. It relates to mixtures that are concentrated solutions and also to the use of the concentrated solutions in water diluted form. Furthermore, it relates to the use of such mixtures for agricultural or materials protection purposes and to the use of one triazole compound to prevent or delay crystallisation of a second triazole compound.

Many biologically active compounds [often referred to as active ingredients, for example pharmaceutical or agrochemical active ingredients] belong to the triazole group of chemicals. Often mixtures of triazole compounds are used because their biological spectra of activity complement one another. In use, the triazoles must often be applied via an aqueous medium; this may require that a concentrated formulation of a triazole is added to a large volume of water, the ‘dilution factor’ [i.e. volume ratio of concentrate to additional water] typically being from 1:1 to 1:1000.

The physical properties of the triazole chemicals vary from compound to compound but invariably the triazoles are either solid or are viscous liquids at room temperature. Some triazoles may exist as a viscous oil plus a solid in equilibrium. Generally, the triazoles have very low solubilities in water at the temperatures at which they are used. The solubility in organic liquids varies significantly from triazole to triazole.

Problems associated with formulating a compound having a low solubility in water are discussed in WO 03/037084, the full content of which is hereby incorporated by reference. One approach is to dissolve a water-insoluble active ingredient in a water-immiscible solvent, such as an aromatic hydrocarbon, to form an emulsifiable concentrate (EC). This can be stored as a stable solution and diluted with water when ready for use to form a milky emulsion of small droplet size. Water-insoluble active ingredients that are not readily soluble in standard water-immiscible solvents may be dissolved in a water-miscible solvent to form a storage stable dispersible concentrate (DC). The active ingredient forms a suspension on dilution with water. Dispersible concentrates of this kind are described in, for example, WO 92/10937, the full content of which is hereby incorporated by reference. These DCs are generally three component formulations in which a solid water-insoluble active ingredient and a dispersant are solubilised in a water-miscible solvent. A range of dispersants are suitable including alkylated vinylpyrrolidone polymers, ethylene oxide propylene oxide/propylene glycol condensates, nonylphenol ethylene oxide adducts and various ethoxylates. The water-miscible solvents include acetonitrile, γ-butyrolactone, dimethyl ketone, dimethylfuran, dimethyl sulphoxide, methanol and N-methylpyrrolidone.

A drawback when using water-miscible solvents for dissolving active ingredients of low water solubility is the poor dilution properties of the resultant DC composition in water; the active ingredient is often rapidly precipitated as coarse crystals giving both application problems, such as syringe, spray filter or nozzle blockage, and poor or inconsistent bioefficacy. To prevent (or, more usually, delay) crystallisation, an excess of emulsifying or dispersing agent, typically at a 1:1 ratio with the active ingredient, may be incorporated but this ratio leads to concentrations of these agents which may give rise to undesirable side-effects, such as phytotoxicity problems.

This problem of crystallisation has been seen when trying to prepare SL formulations containing even just one triazole active ingredient [for example cyproconazole or difenoconazole]; these formulations are known as “solo” formulations. Therefore one formulation approach which has been used with triazole formulations [either “solo” triazole or triazole mixtures] is to prepare a formulation concentrate which relies not only on a water-miscible solvent but also on a water-immiscible solvent, the water-immiscible solvent being present so as to prevent crystallisation of the triazole compounds when the formulation concentrate is added to water.

The water-miscible solvent protects the formulation concentrate against crystallisation at low temperature during storage [for instance, below 5° C.] but when the concentrate is added to water, the water-miscible solvent moves in to the water phase and therefore the water-immiscible solvent, which remains with the triazole, is necessary to prevent or delay crystallisation of the triazole upon dilution of the concentrate in water. The presence of water-immiscible solvent in the formulation concentrate limits the space available for polar water-miscible solvent, which in turn has an impact upon the maximum concentration of triazole that can be present in the formulation concentrate.

Surprisingly, the crystallisation problems discussed above have now been overcome without relying on a water-immiscible solvent [or by using only low levels of water-immiscible solvent] and by developing a formulation system which, although not appropriate for a single triazole active ingredient, does nevertheless work successfully for a mixture of triazoles due to interaction between the triazole active ingredients.

Thus according to the present invention there is provided a composition comprising two or more triazole compounds and a water-miscible solvent characterised in that the composition is significantly free of water-immiscible solvent.

The term ‘significantly free of water-immiscible solvent’ means that the ratio of the total weight of triazole compounds in the composition to the total weight of water-immiscible solvent in the composition is greater than 2 to 1. Suitably, this ratio is greater than 5:1; more suitably it is greater than 10:1; and even more suitably it is greater than 20:1. Most suitably the term means that the composition comprises no water-immiscible solvent.

The interaction between triazoles may be described as having the effect that whilst ‘x’ grammes of a water-immiscible solvent, ‘S’, are required to prepare a “solo-formulation” of ‘X’ grammes of triazole ‘A’; and ‘y’ grammes of a water-immiscible solvent, ‘S’, are required to prepare a “solo-formulation” of ‘Y’ grammes of triazole ‘B’, surprisingly, when a “mixture-formulation” comprising ‘X’ grammes of triazole ‘A’ and ‘Y’ grammes of triazole ‘B’ is prepared, the amount of water-immiscible solvent, ‘S’, required is significantly less than ‘x+y’ grammes.

The compositions of the present invention include not only formulation concentrates [which may be applied to a target directly or may be added to water before the resultant mixture is applied to the target] but also the aforementioned resultant mixture that is obtained when a formulation concentrate is added to water. In a formulation concentrate, the total triazole concentration may typically be from 0.5 to 600 g/l, whilst a typical ‘dilution’ in water may involve one litre of formulation concentrate added to from 1 to 1000 litres of water. Therefore, suitably the total triazole concentration in a composition of the present invention is from 0.0005 to 600 g/l.

In a formulation concentrate, the total amount of triazole used will suitably be from 0.5 to 600 g/l, more usually from 10 to 500 g/l, and typically from 200 to 450 g/l.

The invention is particularly suitable for pharmaceutical, materials protection and agrochemical triazoles, especially agrochemical [pesticidal] triazoles.

Examples of triazoles suitable for use in this invention are cyproconazole, propiconazole, difenoconazole, hexaconazole, penconazole and tebuconazole, ipconazole, metconazole, epoxiconazole and prothioconazole; more suitably cyproconazole, propiconazole, difenoconazole, hexaconazole, penconazole and tebuconazole; and even more suitably cyproconazole, propiconazole and difenoconazole.

In a still further aspect of the invention there is provided the use of a composition as described herein for the protection of industrial materials [referred to as “materials protection”]. Suitably the industrial material to be protected is selected from the group consisting of: wood; plastic; wood plastic composite; paint; paper; and wallboards.

The term “Industrial Material” includes those materials used in construction and the like. For example, Industrial Material may be structural timber, doors, cupboards, storage units, carpets, particularly natural fibre carpets such as wool and hessian, plastics, wood (including engineered wood) and wood plastic composite.

In a particular embodiment the Industrial Material is a coating. “Coating” includes compositions applied to a substrate, for example, paints, stains, varnishes, lacquers, primers, semi-gloss coatings, gloss coatings, flat coatings, topcoats, stain-blocking coatings, penetrating sealers for porous substrates, concrete, marble, elastomeric coatings, mastics, caulks, sealants, board and panelling coatings, transportation coatings, furniture coatings, coil coatings, bridge and tank coatings, surface marking paints, leather coatings and treatments, floor care coatings, paper coatings, personal care coatings [such as for hair, skin or nails], woven and non-woven fabric coatings, pigment printing pastes, adhesive coatings [such as, for example, pressure sensitive adhesives and wet- or dry-laminating adhesives] and plaster.

Suitably “coating” means paint, varnish, stain, lacquer or plaster; more suitably “coating” is a lacquer or alternatively “coating” may mean paint. Paint may comprise, for example, a film former and a carrier (which carrier can be water and/or an organic solvent) and optionally a pigment.

In addition to this, “Industrial Material” includes adhesives, sealants, joining materials, joints and insulation material. In a particular embodiment “Industrial Material” means structural timber. In a further embodiment “Industrial Material” means engineered wood. In a further embodiment “Industrial Material” means plastic.

Plastics includes plastic polymers and copolymers, including: acrylonitrile butadiene styrene, butyl rubber, epoxys, fluoropolymers, isoprene, nylons, polyethylene, polyurethane, polypropylene, polyvinyl chloride, polystyrene, polycarbonate, polyvinylidene fluoride, polyacrylate, polymethyl methacrylate, polyurethane, polybutylene, polybutylene terephthalate, polyether sulfone, polyphenyllenoxide, polyphenylene ether, polyphenylene sulfide, polyphtatamide, polysulphene, polyester, silicone, styrene butadiene rubber and combinations of polymers. In a further embodiment “Industrial Material” means polyvinyl chloride (PVC). In a further embodiment “Industrial Material” means polyurethane (PU). In a further embodiment “Industrial Material” means wood plastic composite (WPC). Wood plastic composite is a material that is well known in the art. A review of WPCs can be found in the following publication—Craig Clemons—Forrest Products Journal. June 2002 Vol 52. No. 6. pp 10-18.

“Wood” is to be understood to include wood and wood products, for example: derived timber products, lumber, plywood, chipboard, flakeboard, laminated beams, oriented strandboard, hardboard, particle-board, tropical wood, structural timber, wooden beams, railway sleepers, components of bridges, jetties, vehicles made of wood, boxes, pallets, containers, telegraph-poles, wooden fences, wooden lagging, windows and doors made of wood, plywood, chipboard, joinery, or wooden products which are used, quite generally, for building houses or decks, in building joinery or wood products that are generally used in house-building including engineered wood, construction and carpentry.

“Industrial Material” also includes cooling lubricants and cooling and heating systems, ventilation and air conditioning systems and parts of production plants, for example cooling-water circuits.

“Industrial Material” also includes wallboards such as gypsum based wallboards.

In a still further aspect of the invention there is provided “Industrial Materials” comprising a composition as herein described. In a particular embodiment said Industrial materials are selected from the group consisting of: wood; plastic; wood plastic composite; paint; paper; and wallboards. In a particular embodiment said Industrial materials comprise wood.

Examples of ways in which a fungus or Industrial Material can be treated with a fungicide according to the invention are: by including said fungicide in the Industrial Material itself, absorbing, impregnating, treating (in closed pressure or vacuum systems) said material with said fungicide, dipping or soaking the building material, or coating the building material for example by curtain coating, roller, brush, spray, atomisation, dusting, scattering or pouring application.

Any water-miscible polar solvent that can dissolve the two or more triazoles may be used in the invention. Suitable solvents include γ-butyrolactone, tetrahydrofurfuryl alcohol, N-methylpyrrolidone, dimethyl sulphoxide, N,N-dimethylformamide, propylene glycol and ethyl lactate. Preferred water-miscible solvents are γ-butyrolactone, ethyl lactate, propylene glycol and tetrahydrofurfuryl alcohol, and a particularly preferred solvent is tetrahydrofurfuryl alcohol. Mixtures of water-miscible polar solvents may also be used. The amount of solvent used is sufficient to bring the total solution to the required final volume of the formulation concentrate.

Although not essential, the compositions of the present invention may include other additives, for instance, polymer stabilisers or anti-settling agents to improve dilution. Examples of suitable stabilisers or anti-settling agents include water soluble and water insoluble polymers such as ethyl cellulose, casein, hydroxy propyl cellulose, Avicel™ CL-611 (based on microcrystalline cellulose), Agrimer™ VEMA AN-216 (a vinylether maleic anhydride copolymer, MW 55,000 to 80,000 Dalton), NU-FILM-P™ (poly-1-p-menthene) and Kelzan™ (a xanthan gum). Such additives are conveniently used in amounts up to 5 g/l, for example 1 to 4 g/l, typically 2.5 g/l, depending on their solubility in the polar water-miscible solvent used. For instance, the maximum amount of Avicel CL-611 and Kelzan that can be dissolved in an N-methylpyrrolidone based concentrate is about 1 g/l.

The composition can also contain emulsifiers to help with the dispersion of the water insoluble active ingredients in water. The emulsifiers can be selected from those commonly used in the art and can be non-ionic, anionic or mixtures thereof. Examples of suitable non-ionic emulsifiers include castor oil ethoxylates, block copolymers, alkylphenol ethoxylates, alcohol ethoxylates, tristyrylphenol ethoxylates, sorbitan esters and their ethoxylate derivatives, fatty acid ethoxylates and alkyl polyglucosides. Examples of anionic emulsifiers include salts of alkylbenzene sulphonic acid, salts of alkylsulphosuccinic acid, alkylaryl phosphate ester ethoxylates and alcohol phosphate ester ethoxylates.

An aqueous fungicidal solution may be applied by spraying, or by any other known technique, to the location requiring treatment.

Thus, in a further aspect of the present invention, there is provided the use of a composition according to any one of the preceding claims to combat or control an agricultural disease which comprises applying to the disease or to a locus of the disease, a fungicidally effective amount of either the composition itself or a combination of the composition and water.

The advantage of the concentrated fungicidal solutions of the present invention is that they can produce sub-micron essentially mono-disperse particles on dilution into water which are stable to subsequent growth for at least 24 hours.

In another aspect of the present invention, there is provided the use of one triazole compound to prevent or delay crystallisation of a second triazole compound.

The compositions of the present invention may also include a further fungicide, such as chlorothalonil.

The invention is illustrated with reference to, but is not limited by, the following Example. In the Example the following abbreviations are used NMP=N-methylpyrrolidone THFA=tetrahydrofurfuryl alcohol

NMP and THFA are both water-miscible solvents; OCTASOLV™ (2-ethylhexyl acetate) is a water-immiscible solvent; GENAPOL™O 100, NANSA™EVM 63/B, EMULSOGEN™EL360 and SOPROPHOR™BSU are each emulsifers; FOAM BLAST™ 281 is an antifoam agent; and LUVITEC™K-30 is a protective colloid.

### EXAMPLE 1

This Example demonstrates that despite the absence of a water-immiscible solvent, non-crystallising compositions comprising two triazole compounds can be prepared even though corresponding compositions with just a single triazole do display crystallisation.

Table 1 provides recipes for 10 samples [referred to as samples A to J]. Each sample was prepared by mixing the individual ingredients together and then gently warming and stirring the mixture until a uniform solution was prepared, which was then allowed to cool to room temperature. Each sample was then assessed for any crystallisation behaviour in the following manner:

A 1% [by volume] dilution was prepared by adding 1 ml of the sample to 100 ml of Standard Hard Water A or D in a stoppered 100 ml measuring cylinder. The diluted sample was then left standing at ambient temperature and examined for the presence of crystalline sediment 24 hours after preparation. The table shows whether or not each sample produced crystals when it was diluted in water [and whether or not any crystallisation had been expected].

Discussion of Results:

Samples A and B contain both a water-miscible solvent and a high concentration of a water-immiscible solvent. As expected, neither sample produced crystals when diluted into water.

By contrast, samples C, D, E and H are very similar to samples A and B but, unlike A and B, they contain no water-immiscible solvent. Surprisingly, despite the omission of a water-immiscible solvent, these samples also did not produce crystals when diluted into water.

Samples F, G, I and J are ‘solo’ compositions [that is, they each contain only one triazole compound, rather than two triazole compounds]. Sample G is essentially sample A but with one triazole [propiconazole] removed. Likewise, sample I is sample E but with cyproconazole removed whilst sample J is sample E but with difenoconazole removed. Sample F has the same basic recipe as samples C, D and E but its single triazole concentration is significantly lower than the total joint triazole concentration in samples C, D and E.

The present invention is demonstrated by the fact that the solo compositions F, G, I and J each had crystallisation problems whereas the mixture compositions C, D, E and H did not crystallise.

TABLE 1

| Ingredient | Sample: | | | | | | | | | |
|---|---|---|---|---|---|---|---|---|---|---|
| [concentration in g/l] | A | B | C | D | E | F | G | H | I | J |
| Cyproconazole | 160 | 80 | 160 | 80 | 150 | 240 | 160 | 160 | — | 150 |
| Propiconazole | 250 | 250 | 250 | 250 | — | — | — | 250 | — | — |
| Difenoconazole | — | — | — | — | 250 | — | — | — | 250 | — |
| OCTASOLV (2-ethylhexyl | to 1 | to 1 | — | — | — | — | to 1 | — | — | — |
| acetate) | litre | litre | | | | | litre | | | |
| NMP | 100 | 100 | — | — | — | — | 100 | to 1 | — | — |
| | | | | | | | | litre | | |
| GENAPOL O 100 | 60 | 60 | — | — | — | — | 60 | 60 | — | — |
| NANSA EVM 63/B | 50 | 50 | 21 | 21 | 21 | 21 | 50 | 50 | 21 | 21 |
| EMULSOGEN EL360 | 70 | 70 | 63 | 63 | 63 | 63 | 70 | 70 | 63 | 63 |
| SOPROPHOR BSU | — | — | 126 | 126 | 126 | 126 | — | — | 126 | 126 |
| THFA | — | — | to 1 | to 1 | to 1 | to 1 | — | — | to 1 | to 1 |
| | | | litre | litre | litre | litre | | | litre | litre |
| FOAM BLAST 281 | — | — | 1 | 1 | 1 | 1 | — | — | — | — |
| LUVITEC K-30 | — | — | 2 | 2 | 2 | 2 | — | — | — | — |
| Any crystallisation upon | No | No | No | No | No | Yes | No - after | No | Yes | Yes |
| dilution in water? | | | | | | | 24 hours | | | |
| | | | | | | | [Yes - after | | | |
| | | | | | | | 2 weeks]. | | | |
| Was crystallisation expected? | No | No | Yes | Yes | Yes | Yes | No | Yes | Yes | Yes |

1. A composition comprising two or more triazole compounds selected from cyproconazole, propiconazole and difenoconazole and a water-miscible solvent characterised in that the composition is substantially free of water-immiscible solvent.

2. A composition according to claim 1 wherein the total concentration of the triazole compounds is from 0.0005 to 600 grammes per litre.

3. A composition according to claim 1 in which the water-miscible solvent is γ-butyrolactone, tetrahydrofurfuryl alcohol, N-methyl pyrrolidone, dimethyl sulphoxide, N,N-dimethylformamide, propylene glycol or ethyl lactate; or is a mixture of any of these solvents.

4. (canceled)

5. A method of combating or controlling an agricultural disease which comprises applying to the disease or to a locus of the disease, a fungicidally effective amount of: a composition comprising two or more triazole compounds selected from cyproconazole, propiconazole and difenoconazole and a water-miscible solvent characterised in that the composition is substantially free of water-immiscible solvent, or a combination of said composition and water.

6. A method of using a first triazole compound to prevent or delay the crystallisation of a second triazole compound which comprises:
Providing a composition which is significantly free of water-immiscible solvent and which comprises said second triazole compound and a water-miscible solvent
adding the composition to water in the presence of said first triazole compound.

7. The method according to claim 6 wherein the triazole compounds are agrochemical or materials protection active ingredients.

8. The method according to claim 7 in which the triazole compounds are selected from cyproconazole, propiconazole, difenoconazole, hexaconazole, penconazole and tebuconazole, ipconazole, metconazole, epoxiconazole and prothioconazole.

9. The method according to claim 8 in which the triazole compounds are selected from cyproconazole, propiconazole and difenoconazole.
